(19) United States
(12) Patent Application Publication
(10) Pub. No.: US 2003/0022576 A1
(43) Pub. Date: Jan. 30, 2003

(54) Microbicidal wallcoverings

(75) Inventors: Peter Ottersbach, Windeck (DE); Martina Inhester, Herten (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS Gesellschaft fuer Tech. und Innovation mbH, Marl (DE)

(21) Appl. No.: 10/199,255

(22) Filed: Jul. 22, 2002

(30) Foreign Application Priority Data
Jul. 21, 2001 (DE) 10135667.6

(51) Int. Cl. B32B 27/04; B32B 3/00; B32B 5/02; B32B 9/04; B32B 27/12; B32B 9/00

(52) U.S. Cl. 442/123; 442/59; 442/152; 442/153

(57) ABSTRACT

The invention relates to microbicidal wallcoverings and methods of making the same.

### CROSS-REFERENCE TO RELATED APPLICATIONS

The present application claims priority to German Application No. DE 101 35 667.6, filed on Jul. 21, 2001, which is hereby incorporated by reference in its entirety.

### BACKGROUND OF THE INVENTION

1. Field of the Invention

The invention relates to microbicidal wallcoverings comprising one or more antimicrobial polymer and methods of making the same.

2. Discussion of the Background

The surfaces of pipelines, containers, and packaging are susceptible to undesirable colonization and propagation of bacteria. Coats of slime can form on these surfaces, which give rise to extremely high levels of microbial populations. This phenomenon can adversely affect the quality of water, beverages, and foods intended for human consumption because it causes these products to decay. Therefore, it may even damage the health of consumers.

Good hygiene is important for products intended for human consumption or intimate human contact, including the treatment, prevention, and reduction of bacterial growth on these products. These products may include textiles, especially those textiles intended for use near and around the genital area of individuals. Further, good hygiene is required for textiles required in the care of the sick and the elderly.

Good hygiene is required in and around hospitals. This includes hospital wards, areas for medical interventions, and toilets. Examples of hospital wards include but are not limited to intensive care, neonatal and isolation wards. Isolation wards include those in which critical cases of infection are treated. There is a need for bacteria to be kept away from all surfaces, such as surfaces of furniture and instruments, in and around hospitals.

The growth of microbes may also adversely affect many industrial systems. In particular, separating materials, which utilize membranes or filters are severely impaired by the deposition and growth of microbes. In seawater desalination the growth of marine algae in the system may shorten running times, while the growth of biofilms may prematurely block the filter cake in deep-bed filtration. To counter the growth of biofilms, crossflow filtration has been employed. Crossflow filtration utilizes a specified flow perpendicular to the plane of filtration. However, this method has proven to be industrially inadequate.

At present, surfaces of furniture, textiles, and equipment are commonly treated with chemicals or solutions with broad and general antimicrobial activity to prevent bacterial colonization. These general antimicrobial chemical agents act nonspecifically and frequently act as a human irritant or are either directly toxic or its degradation products are toxic. An additional problem associated with these broadly nonspecific antimicrobial chemicals is an increased intolerance among humans arising from frequent contact.

A critically important aspect of personal preventative health care is the elimination of microbes, in particular mold infestation, from interior surfaces of occupied areas of buildings. Interior surfaces covered with wallcoverings are particularly conspicuous, since the commonly used wallcoverings prevent the “breathing” of building materials. The reduced breathability exacerbates condensation of atmospheric moisture and reduces moisture dissipation from, and therefore drying of, damp walls resulting in increased mold formation.

Statistically, each German citizen hangs two rolls of interior wallcoverings annually, corresponding to a total of about 140 million rolls of wallcoverings nationwide. The most popular of these are vinyl wallcoverings. The production demand for vinyl wallcoverings alone is nearly 25,000 tons of PVC paste per annum. The resulting vinyl wallcoverings are particularly problematic with a water-vapor permeability (breathability) ranging from 200 to 300 centimeters, as classified by DIN 52615 by taking an equivalent air layer thickness. In contrast, the water-vapor permeability for paper wallcoverings ranges from 5 to 10 centimeters. Vinyl wallcoverings are often admixed with low-molecular-weight plasticizers, which may be metabolized by microorganisms thereby further stimulating microbial growth. Since the growth often begins within the building materials, it occurs beneath the visible surface. Therefore, contaminated sites are very difficult to visually identify. Accordingly, microbial growth is often first detected through adverse health effects, which may manifest in diseases of the skin or the respiratory tract and assorted allergic reactions. Mold spores, particularly of the genera Aspergillus and Cladosporium, have been frequently detected in air samples taken from buildings in Germany in which people have been so affected. Accordingly, there exists a strong social desire to minimize the negative health effects associated with the poor breathability of typical wallcoverings.

Textile wallcoverings are another commonly used wallcovering. These wallcoverings typically apply textile fibers, for example natural fibers (such as cotton, jute, silk, or linen) or synthetic fibers (such as viscose), to paper backings. Generally, these materials are applied by gluing the fibers or threads onto a mono-ply or multi-ply paper layer. In the case of velour wallcoverings, which also belongs to the textile wallcoverings group, a bed of adhesive on the paper backing is flocked electrostatically with short silk fibers or synthetic fibers, giving a velvet-like sheen to the surface.

The fibers of natural textiles are generally capable of absorbing and releasing water vapor present in the room; however, the absorption of water vapor may give rise to microbial infestation, since the fibers have large surface areas over which microorganisms may colonize. In some instances, microbial colonies may even begin to metabolize the textile wallcovering. Microbe infestations of textile wallcoverings are more prevalent in areas with inadequate ventilation, for example areas between closets or furniture and the wall.

In yet another class of wallcoverings, woodchip wallcoverings, the large surface area of the wood fibers allows relatively large amounts of water vapor to be readily absorbed. Similar to the textile wallcoverings, inadequate ventilation or dissipation of the absorbed water may lead to microbial infestations.

Therefore, the incorporation of biocides in wallcoverings (particularly vinyl wallcoverings) could suppress or eliminate microbial infestation, which arise from poor moisture dissipation and nutrient sources in the building materials or plasticizers used in the wallcoverings. Generally, approach to this problem has been to employ chemicals found in “antimold paints” or “mold removers.” These chemicals include sodium hypochlorite, formaldehyde, and isothiazoline derivatives. However, these chemicals are acutely toxic and highly allergenic. Furthermore, these toxic compounds are rapidly consumed, thereby offering a very short period of antimicrobial protection or requiring the use of significantly larger quantities of the compounds, leading to further health problems.

Accordingly, it is highly desirable to find a means to overcome the inherent problems associated with the use of common wallcoverings and the further problems associated with the use of toxic chemicals. Such a means would ideally exhibit efficient and prolonged microbicidal action, have very little or no toxicity to higher organisms, do not dissipate into the ambient air, and do not cross-react with the wallcoverings. The present inventors have found that the sought after properties may be filled by employing antimicrobial polymers in wallcoverings.

European Patent application 0 862 858 describes copolymers of tert-butylaminoethyl methacrylate, a methacrylic ester with a secondary amino function. Such copolymers possess microbial biocide properties. This terpolymer has been found to possess “contact microbial biocide” properties in the absence of an additional microbial biocide. A “contact microbial biocide” is any polymer that does not include any low molecular mass constituents. Therefore, the antimicrobial property of a “contact microbial biocide” is derived from the contact between the bacteria and the surface of the polymer. The following patent applications describe a large number of antimicrobial “contact microbial biocide” polymers that are known: DE 100 24 270, DE 100 22 406, PCT/EP00/06501, DE 100 14 726, DE 100 08 177, PCT/EP00/06812, PCT/EP00/06487, PCT/EP00/06506, PCT/EP00/02813, PCT/EP00/02819, PCT/EP00/02818, PCT/EP00/02780, PCT/EP00/02781, PCT/EP00/02783, PCT/EP00/02782, PCT/EP00/02799, PCT/EP00/02798, PCT/EP00/00545, PCT/EP00/00544.

Finally, research has shown that microbes are developing resistance to antimicrobial treatments as they adapt to overcome antibiotics. Therefore, it will be necessary to develop systems based on new classes of compositions having improved antimicrobial efficacy.

### SUMMARY OF THE INVENTION

One object of the present invention is wallcoverings that can be given microbicidal properties by using antimicrobial polymers.

This object may be achieved by adding 0.01 to 70% by weight of at least one antimicrobial polymer to the wallcoverings. This proportion by weight is based on the wallcovering per se, irrespective of which layer comprises the antimicrobial polymer.

In another object of the present invention the antimicrobial polymers may be admixed with another polymer resulting in a weight ratio ranging from 1 to 75% by weight, preferable 5 to 50% by weight, of antimicrobial polymers in the resulting polymer blend.

Another object of the present invention is to provide a process for producing antimicrobial wallcoverings by providing a paper backing with a coating containing at least one antimicrobial polymer.

A further object of the present invention is to provide a process for producing antimicrobial wallcoverings by securing polymer fibers or textile fibers, or combinations thereof, which contain at least one antimicrobial polymer to a paper backing.

In another object of the present invention, antimicrobial wallcoverings may be produced by a process comprising securing polymer fibers or textile fibers, or combinations thereof, to a paper backing which contains at least one antimicrobial polymer.

Another object of the present invention is to provide a process for producing antimicrobial wallcoverings by adding at least one antimicrobial polymer to a mixture made from at least one of paper fibers, pulp, wood particles, woodchips, cellulose, polymer fibers, or textile fibers, or combinations thereof, and processing the mixture to generate a paper backing.

In the objects of the present invention, the antimicrobial polymer has a weight-average molecular weight of 20,000 to 5,000,000, preferably 50,000 to 1,000,000, and most preferably 100,000 to 500,000.

The above objects highlight certain aspects of the invention. Additional objects, aspects and embodiments of the invention are found in the following detailed description of the invention.

### DETAILED DESCRIPTION OF THE INVENTION

Unless specifically defined, all technical and scientific terms used herein have the same meaning as commonly understood by a skilled artisan in biochemistry, chemistry, and materials science.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

In view of the above, a need exists to provide wallcoverings with antimicrobial properties. The present invention provides wallcoverings that can be given microbicidal properties by using antimicrobial polymers.

This object may be achieved by adding 0.01 to 70% by weight of at least one antimicrobial polymer to the wallcoverings. This proportion by weight is based on the wallcovering per se, irrespective of which layer comprises the antimicrobial polymer.

In one embodiment, admixing polymers used in wall coverings (e.g., vinyl polymers), fibers, wood particles, or cellulose with the antimicrobial polymers may produce the wallcovering of the present invention. In a further embodiment, the antimicrobial polymers may be present in a coating, which is applied to a paper backing of the wallcoverings.

The present invention further provides antimicrobial polymer blends that may be used with the aforementioned wallcoverings. In this embodiment, the antimicrobial polymers may be admixed with another polymer resulting in a weight ratio ranging from 1 to 75% by weight, preferable 5 to 50% by weight, of antimicrobial polymers in the resulting polymer blend.

The invention also relates to a process for producing antimicrobial wallcoverings. By this method wallcoverings, in particular vinyl wallcoverings, can be made that possess microbicidal properties.

One process includes providing a paper backing which contains antimicrobial polymers or a polymer blend containing antimicrobial polymers. Another process includes adding antimicrobial polymers to a mixture made from paper, pulp, textiles, cellulose, wood particles, or woodchips, or combinations thereof, processing the mixture, and subsequently securing the processed mixture to a wallcovering as a wallcovering web paper backing. Another process includes securing to a paper backing admixtures of textile fibers, cotton fibers, jute fibers, silk fibers, viscose fibers, or polymer fibers, or combinations thereof, with antimicrobial polymers. Still another process includes securing a mixture made from textile fibers, cotton fibers, jute fibers, silk fibers, viscose fibers, or polymer fibers, or combinations thereof, to a paper backing that contains antimicrobial polymers. Another process of the present invention includes providing a paper backing that containing antimicrobial polymers that has been prepared by thermal gelling of a plastisol, preferably made from EPVC.

The resultant wallcoverings may be further processed to give any of the commercial products, if not performed prior to addition of the layer containing the antimicrobial polymers, which hitherto have been provided in unmodified wallcoverings. These process to provide final commercial products include coloring, printing, or embossing of the walleoverings to provide desirable aesthetic properties. The artisan may find methods of production, primary processing, printing, and embossing commonly employed for producing the wallcoverings by reference to Kunststoff-Handbuch Polyvinylchlorid, Vol. 2/2, 1986, pp. 1077-1128.

The antimicrobial polymers utilized in the present invention possess “contact microbial biocide” properties in the absence of an additional microbial biocide. A “contact microbial biocide” is any polymer that does not include any low molecular mass constituents. Therefore, the antimicrobial property of a “contact microbial biocide” is derived from the contact between the bacteria and the surface of the polymer.

In preparing the antimicrobial polymers, it is preferable to use nitrogen- or phosphorus-functionalized monomers. In particular, these polymers are prepared from at least one of the following monomers:

2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl methacrylate, dimethylaminopropylmethacrylamide, diethylaminopropylmethacrylamide, N-3dimethylaminopropylacrylamide, 2-methacryloyloxyethyltrimethylammonium methosulfate, 2-diethyl-aminoethyl methacrylate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1 -propanesulfonic acid, 2-diethylaminoethyl vinyl ether, and 3-aminopropyl vinyl ether.

If desired, the antimicrobial polymers may be copolymers of the aforementioned nitrogen- or phosphorus-functionalized monomers and other aliphatically unsaturated monomers. In particular, these are based on acrylates or methacrylates. Examples of preferred aliphatically unsaturated monomers include acrylic acid, tert-butyl methacrylate, methyl methacrylate, styrene or its derivatives, vinyl chloride, vinyl ethers, acrylamides, acrylonitriles, olefins (ethylene, propylene, butylene, isobutylene), allyl compounds, vinyl ketones, vinylacetic acid, vinyl acetate, and vinyl esters. Particularly preferred aliphatically unsaturated monomers include methyl methacrylate, ethyl methacrylate, butyl methacrylate, tert-butyl methacrylate, methyl acrylate, ethyl acrylate, butyl acrylate, and tert-butyl acrylate.

The antimicrobial polymers of the present application, and highlighted above, have a weight-average molecular weight of 20,000 to 5,000,000, preferably 50,000 to 1,000,000, and most preferably 100,000 to 500,000.

The proportion of antimicrobial polymer in the wallcoverings may be 0.01 to 70% by weight, preferably 0.1 to 40% by weight, and most preferably 0.1 to 20% by weight. This proportion by weight is based on the wallcovering per se; irrespective of which layer comprises the antimicrobial polymer.

The antimicrobial polymer of the present invention may also be used in conjunction with other polymers in the form of a polymer blend. Polymers that may be used in conjunction with the antimicrobial polymers include PVC, polyurethane, polystyrenes, polymethyl methacrylate, polyethylene, polypropylene, and polyacrylates, or combinations thereof. When the aforementioned polymers are admixed with the antimicrobial polymers, the antimicrobial polymers should comprise a weight ratio ranging from 1 to 75% by weight, preferable 5 to 50% by weight, of the resulting polymer blend.

The plastisols, preferably made from EPVC, used in the present invention may contain other materials in addition to antimicrobial polymer. Examples of suitable materials include solvents (such as hydrocarbons, paraffins, isopropanol, or water), stabilizers, plasticizers (such as DINP, DOP, and DINCH), and pigments. The plastisols may be applied to the wallcovering backings and gelled at a temperature of 100° C. to 200° C. When the surface to be covered requires the use of a structured wallcovering, the plastisol may also include blowing agents, such as azodicarbonamide.

The materials used to produce the wallcoverings of the present invention are not particularly limited and may be any of the macromolecules commonly used in the field. Examples of some of the more commonly employed materials include paper, pulp, textiles, cellulose, wood particles, woodchips, textile fibers, cotton fibers, jute fibers, silk fibers, viscose fibers, or polymer fibers (in particular PVC), or combinations thereof

The methods described above give wallcoverings which have antimicrobial properties and which combine, in an almost ideal manner, the mechanical and processing properties required to propagate a biochemical inhibitoryreaction of growth of microbes. Since the antimicrobial polymers have been secured within the matrix of the wallcoverings and no low-molecular-weight constituents are released into the environment, systems of this type are suitable for use in areas requiring good hygiene as highlighted in the Discussion of the Background, above.

Having generally described this invention, a further understanding can be obtained by reference to certain specific examples, which are provided herein for purposes of illustration only, and are not intended to be limiting unless otherwise specified. As can be seen from the following examples, the process according to the present invention can significantly reduce microbial infestation on the interior surfaces of buildings.

### EXAMPLES

### Example 1

40 mL of dimethylaminopropylmethacrylamide (Aldrich) and 200 mL of ethanol were charged to a three-necked flask and heated to 65° C. under a stream of argon. 0.4 g of azobisisobutyronitrile dissolved in 20 mL of ethanol was then slowly added dropwise, with stirring. The mixture was heated to 70° C. and stirred at this temperature for 6 hours. Subsequently, the solvent was removed from the reaction mixture by distillation, and the product was dried in vacuo at 50° C. for 24 hours. The product was then dissolved in 200 mL of acetone, subjected to distillation to remove the solvent, and dried in vacuo at 50° C. for 24 hours, and finely ground in a mortar.

### Example 1a

27 g of dioctyl phthalate, 13 g of Bärostab KK 47 S (mixed metal stabilizer from Bärlocher), 28 g of azodicarbonamide, 50 g of titanium dioxide, 136 g of calcium carbonate, 5.2 g of water, and 22 g of isoparaffin were weighed out into a 400-mL polypropylene beaker. The mixture was then incorporated, using a spatula, and homogenized for 4 minutes, using a dissolver. A 21-g aliquot of this mixture was removed and placed in a 400-mL polypropylene beaker with 24 g of di-2-ethylhexyl phthalate, 5 g of the product from Example 1, and 46 g of polyvinyl chloride. This resulting mixture was carefully incorporated, using a spatula, and then homogenized for 1 minute, using a dissolver, and then allowed to stand for 2 hours.

### Example 1b

A wallcovering paper was placed into a 30×40-cm clamping frame. The clamping frame with the wallcovering paper was suspended for a period of 15 seconds in a 200° C. preheated oven to tension the paper. The mixture from Example 1 a was then applied to one end face of the paper and applied to the paper, using a 300-μm doctor. The resultant coated paper was subsequently foamed in an oven at 200° C. for 60 seconds, removed, and cooled to ambient temperature. A 4×3-cm specimen was cut out of this coated wallcovering paper.

### Example 1c

The coated piece of wallcovering from Example 1b was placed on the base of a glass beaker containing 10 mL of a test microbial suspension of 10⁷ Pseudomonas aeruginosa microbes per mL and shaken for 4 hours. A 1-mL aliquot of the test microbial suspension was then removed, from which it was determined that the number of microbes had been reduced to 10⁴ Pseudomonas aeruginosa microbes per mL.

### Example 1d

The coated piece of wallcovering from Example 1b was placed on the base of a glass beaker containing 10 mL of a test microbial suspension of 10⁷ Staphylococcus aureus microbes per mL and shaken for 4 hours. A 1-mL aliquot of the test microbial suspension was then removed, from which it was determined that no remaining Staphylococcus aureus microbes were detectable.

### Example 1e

Pieces of coated wallcovering from Example 1b were inoculated with, respectively, Chlorella sp., Trentepohlia sp., Gloeocapsa sp., Calothrix sp., and Aspergilus niger. These specimens were then placed in an incubator for 3 weeks. In contrast to the simultaneously performed control specimens, none of the impregnated specimens exhibited any detectable growth.

### Example 2

40 mL of tert-butylaminoethyl methacrylate (Aldrich) and 200 mL of ethanol were charged to a three-necked flask and heated to 65° C. under a stream of argon. 0.4 g of azobisisobutyronitrile dissolved in 20 mL of ethanol was then slowly added dropwise, with stirring. The mixture was heated to 70° C. and stirred at this temperature for 6 hours. Subsequently, the solvent was removed from the reaction mixture by distillation, and the product was dried in vacuo at 50° C. for 24 hours. The product was then dissolved in 200 mL of acetone, subjected to distillation to remove the solvent, and dried in vacuo at 50° C. for 24 hours, and finely ground in a mortar.

### Example 2a

27 g of dioctyl phthalate, 13 g of Bärostab KK 47 S (mixed metal stabilizer from Bärlocher), 28 g of azodicarbonamide, 50 g of titanium dioxide, 136 g of calcium carbonate, 5.2 g of water, and 22 g of isoparaffin were weighed out into a 400-mL polypropylene beaker. The mixture was then incorporated, using a spatula, and homogenized for 4 minutes, using a dissolver. A 21-g aliquot of this mixture was removed and placed in a 400-mL polypropylene beaker with 24 g of di-2-ethylhexyl phthalate, 5 g of the product from Example 2, and 46 g of polyvinyl chloride. This resulting mixture was carefully incorporated, using a spatula, and then homogenized for 1 minute, using a dissolver, and then allowed to stand for 2 hours.

### Example 2b

A wallcovering paper was placed into a 30×40-cm clamping frame. The clamping frame with the wallcovering paper was suspended for a period of 15 seconds in a 200° C. preheated oven to tension the paper. The mixture from Example 2a was then applied to one end face of the paper and applied to the paper, using a 300-μm doctor. The resultant coated paper was subsequently foamed in an oven at 200° C. for 60 seconds, removed, and cooled to ambient temperature. A 4×3-cm specimen was cut out of this coated wallcovering paper.

### Example 2c

The coated piece of wallcovering from Example 2b was placed on the base of a glass beaker containing 10 mL of a test microbial suspension of 10⁷ Pseudomonas aeruginosa microbes per mL and shaken for 4 hours. A 1-mL aliquot of the test microbial suspension was then removed, from which it was determined that the number of microbes had been reduced to 10² Pseudomonas aeruginosa microbes per mL.

### Example 2d

The coated piece of wallcovering from Example 2b was placed on the base of a glass beaker containing 10 mL of a test microbial suspension of 10⁷ Staphylococcus aureus microbes per mL and shaken for 4 hours. A 1-mL aliquot of the test microbial suspension was then removed, from which it was determined that no remaining Staphylococcus aureus microbes were detectable.

### Example 2e

Pieces of coated wallcovering from Example 2b were inoculated with, respectively, Chlorella sp., Trentepohlia sp., Gloeocapsa sp., Calothrix sp., and Aspergilus niger. These specimens were then placed in an incubator for 3 weeks. In contrast to the simultaneously performed control specimens, none of the impregnated specimens exhibited any detectable growth.

### Example 3

6 g of 3-aminopropyl vinyl ether (Aldrich), 6 g of methyl methacrylate (Aldrich), and 60 mL of ethanol were charged to a three-necked flask and heated to 65° C. under a stream of argon. 0.15 g of azobisisobutyronitrile dissolved in 4 mL of ethyl methyl ketone was then slowly added dropwise, with stirring. The mixture was heated to 70° C. and stirred at this temperature for 72 hours. Subsequently, the reaction mixture was stirred into 0.5 L of deionized water, whereupon the polymeric product precipitated out of solution. The polymer was then filtered off and the filter residue was rinsed with 100 mL of deionized water to remove any residual monomers. The product was dried in vacuo at 50° C. for 24 hour.

### Example 3a

27 g of dioctyl phthalate, 13 g of Bärostab KK 47 S (mixed metal stabilizer from Bärlocher), 28 g of azodicarbonamide, 50 g of titanium dioxide, 136 g of calcium carbonate, 5.2 g of water, and 22 g of isoparaffin were weighed out into a 400-mL polypropylene beaker. The mixture was then incorporated, using a spatula, and homogenized for 4 minutes, using a dissolver. A 21-g aliquot of this mixture was removed and placed in a 400-mL polypropylene beaker with 24 g of di-2-ethylhexyl phthalate, 5 g of the product from Example 3, and 46 g of polyvinyl chloride. This resulting mixture was carefully incorporated, using a spatula, and then homogenized for 1 minute, using a dissolver, and then allowed to stand for 2 hours.

### Example 3b

A wallcovering paper was placed into a 30×40-cm clamping frame. The clamping frame with the wallcovering paper was suspended for a period of 15 seconds in a 200° C. preheated oven to tension the paper. The mixture from Example 3a was then applied to one end face of the paper and applied to the paper, using a 300-μm doctor. The resultant coated paper was subsequently foamed in an oven at 200° C. for 60 seconds, removed, and cooled to ambient temperature. A 4×3-cm specimen was cut out of this coated wallcovering paper.

### Example 3c

The coated piece of wallcovering from Example 3b was placed on the base of a glass beaker containing 10 mL of a test microbial suspension of 10⁷ Pseudomonas aeruginosa microbes per mL and shaken for 4 hours. A 1-mL aliquot of the test microbial suspension was then removed, from which it was determined that the number of microbes had been reduced to 10² Pseudomonas aeruginosa microbes per mL.

### Example 3d

The coated piece of wallcovering from Example 3b was placed on the base of a glass beaker containing 10 mL of a test microbial suspension of 10⁷ Staphylococcus aureus microbes per mL and shaken for 4 hours. A 1-mL aliquot of the test microbial suspension was then removed, from which it was determined that no remaining Staphylococcus aureus microbes were detectable.

### Example 3e

Pieces of coated wallcovering from Example 3b were inoculated with, respectively, Chlorella sp., Trentepohlia sp., Gloeocapsa sp., Calothrix sp., and Aspergilus niger. These specimens were then placed in an incubator for 3 weeks. In contrast to the simultaneously performed control specimens, none of the impregnated specimens exhibited any detectable growth.

### Example 4

A polymer containing tert-butylaminoethyl methacrylate was prepared as described in Example 2.

### Example 4a

27 g of dioctyl phthalate, 13 g of Bärostab KK 47 S (mixed metal stabilizer from Bärlocher), 28 g of azodicarbonamide, 50 g of titanium dioxide, 136 g of calcium carbonate, 5.2 g of water, and 22 g of isoparaffin were weighed out into a 400-mL polypropylene beaker. The mixture was then incorporated, using a spatula, and homogenized for 4 minutes, using a dissolver. A 21-g aliquot of this mixture was removed and placed in a 400-mL polypropylene beaker with 24 g of di-2-ethylhexyl phthalate, 5 g of the product from Example 2, and 48 g of polyvinyl chloride. This resulting mixture was carefully incorporated, using a spatula, and then homogenized for 1 minute, using a dissolver, and then allowed to stand for 2 hours.

### Example 4b

A wallcovering paper was placed into a 30×40-cm clamping frame. The clamping frame with the wallcovering paper was suspended for a period of 15 seconds in a 200° C. preheated oven to tension the paper. The mixture from Example 4a was then applied to one end face of the paper and applied to the paper, using a 300-μm doctor. The resultant coated paper was subsequently foamed in an oven at 200° C. for 60 seconds, removed, and cooled to ambient temperature. A 4×3-cm specimen was cut out of this coated wallcovering paper.

### Example 4c

The coated piece of wallcovering from Example 4b was placed on the base of a glass beaker containing 10 mL of a test microbial suspension of 10⁷ Pseudomonas aeruginosa microbes per mL and shaken for 4 hours. A 1-mL aliquot of the test microbial suspension was then removed, from which it was determined that the number of microbes had been reduced to 10³ Pseudomonas aeruginosa microbes per mL.

### Example 4d

The coated piece of wallcovering from Example 4b was placed on the base of a glass beaker containing 10 mL of a test microbial suspension of 10⁷ Staphylococcus aureus microbes per mL and shaken for 4 hours. A 1-mL aliquot of the test microbial suspension was then removed, from which it was determined that no remaining Staphylococcus aureus microbes were detectable.

### Example 4e

Pieces of coated wallcovering from Example 4b were inoculated with, respectively, Chlorella sp., Trentepohlia sp., Gloeocapsa sp., Calothrix sp., and Aspergilus niger. These specimens were then placed in an incubator for 3 weeks. In contrast to the simultaneously performed control specimens, none of the impregnated specimens exhibited any detectable growth.

### Example 5

A polymer of 3-aminopropyl vinyl ether and methyl methacrylate was prepared as described in Example 3.

### Example 5a

27 g of dioctyl phthalate, 13 g of Bärostab KK 47 S (mixed metal stabilizer from Bärlocher), 28 g of azodicarbonamide, 50 g of titanium dioxide, 136 g of calcium carbonate, 5.2 g of water, and 22 g of isoparaffin were weighed out into a 400-mL polypropylene beaker. The mixture was then incorporated, using a spatula, and homogenized for 4 minutes, using a dissolver. A 21-g aliquot of this mixture was removed and placed in a 400-mL polypropylene beaker with 24 g of di-2-ethylhexyl phthalate, 1 g of the product from Example 3, and 49 g of polyvinyl chloride. This resulting mixture was carefully incorporated, using a spatula, and then homogenized for 1 minute, using a dissolver, and then allowed to stand for 2 hours.

### Example 5b

A wallcovering paper was placed into a 30×40-cm clamping frame. The clamping frame with the wallcovering paper was suspended for a period of 15 seconds in a 200° C. preheated oven to tension the paper. The mixture from Example 5a was then applied to one end face of the paper and applied to the paper, using a 300-μm doctor. The resultant coated paper was subsequently foamed in an oven at 200° C. for 60 seconds, removed, and cooled to ambient temperature. A 4×3-cm specimen was cut out of this coated wallcovering paper.

### Example 5c

The coated piece of wallcovering from Example 5b was placed on the base of a glass beaker containing 10 mL of a test microbial suspension of 10⁷ Pseudomonas aeruginosa microbes per mL and shaken for 4 hours. A 1-mL aliquot of the test microbial suspension was then removed, from which it was determined that the number of microbes had been reduced to 10⁴ Pseudomonas aeruginosa microbes per mL.

### Example 5d

The coated piece of wallcovering from Example 5b was placed on the base of a glass beaker containing 10 mL of a test microbial suspension of 10⁷ Staphylococcus aureus microbes per mL and shaken for 4 hours. A 1-mL aliquot of the test microbial suspension was then removed, from which it was determined that the number of microbes had been reduced to 10³ Staphylococcus aureus microbes per mL.

### Example 5e

Pieces of coated wallcovering from Example 5b were inoculated with, respectively, Chlorella sp., Trentepohlia sp., Gloeocapsa sp., Calothrix sp., and Aspergilus niger. These specimens were then placed in an incubator for 3 weeks. In contrast to the simultaneously performed control specimens, none of the impregnated specimens exhibited any detectable growth.

### Example 6

A polymer containing tert-butylaminoethyl methacrylate was prepared as described in Example 2.

### Example 6a

27 g of dioctyl phthalate, 13 g of Bärostab KK 47 S (mixed metal stabilizer from Bärlocher), 28 g of azodicarbonamide, 50 g of titanium dioxide, 136 g of calcium carbonate, 5.2 g of water, and 22 g of isoparaffin were weighed out into a 400-mL polypropylene beaker. The mixture was then incorporated, using a spatula, and homogenized for 4 minutes, using a dissolver. A 21-g aliquot of this mixture was removed and placed in a 400-mL polypropylene beaker with 24 g of di-2-ethylhexyl phthalate, 10 g of the product from Example 2, and 40 g of polyvinyl chloride. This resulting mixture was carefully incorporated, using a spatula, and then homogenized for 35 minutes, using a dissolver, and then allowed to stand for 2 hours.

### Example 6b

A wallcovering paper was placed into a 30×40-cm clamping frame. The clamping frame with the wallcovering paper was suspended for a period of 15 seconds in a 200° C. preheated oven to tension the paper. The mixture from Example 6a was then applied to one end face of the paper and applied to the paper, using a 300-μm doctor. The resultant coated paper was subsequently foamed in an oven at 200° C. for 60 seconds, removed, and cooled to ambient temperature. A 4×3-cm specimen was cut out of this coated wallcovering paper.

### Example 6c

The coated piece of wallcovering from Example 6b was placed on the base of a glass beaker containing 10 mL of a test microbial suspension of 10⁷ Pseudomonas aeruginosa microbes per mL and shaken for 4 hours. A 1-mL aliquot of the test microbial suspension was then removed, from which it was determined that no remaining Pseudomonas aeruginosa microbes were detectable.

### Example 6d

The coated piece of wallcovering from Example 6b was placed on the base of a glass beaker containing 10 mL of a test microbial suspension of 10⁷ Staphylococcus aureus microbes per mL and shaken for 4 hours. A 1-mL aliquot of the test microbial suspension was then removed, from which it was determined that no remaining Staphylococcus aureus microbes were detectable.

### Example 6e

Pieces of coated wallcovering from Example 6b were inoculated with, respectively, Chlorella sp., Trentepohlia sp., Gloeocapsa sp., Calothrix sp., and Aspergilus niger. These specimens were then placed in an incubator for 3 weeks. In contrast to the simultaneously performed control specimens, none of the impregnated specimens exhibited any detectable growth.

Numerous modifications and variations on the present invention are possible in light of the above teachings. It is, therefore, to be understood that within the scope of the accompanying claims, the invention may be practiced otherwise than as specifically described herein.

What is claimed is:

1. A wallcovering comprising 0.01 to 70% by weight of at least one antimicrobial polymer.

2. The wallcovering according to claim 1, further comprising a non-biocidal polymer.

3. The wallcovering according to claim 4, wherein said non-biocidal polymer is selected from the group consisting of PVC, polyurethane, polystyrene, polymethyl methacrylate, polyethylene, polypropylene, and polyacrylates, and mixtures thereof.

4. The wallcovering according to claim 1, further comprising paper fibers, pulp, wood particles, woodchips, cellulose, polymer fibers, textile fibers, cotton fibers, jute fibers, silk fibers, linen fibers, viscose fibers, or velour fibers, or combinations thereof.

5. The wallcovering according to claim 1, wherein said antimicrobial polymer comprises nitrogen-functionalized monomers, phosphorous-functionalized monomers, or combinations thereof.

6. The wallcovering according to claim 1, wherein said antimicrobial polymer comprises at least one monomer selected from the group consisting of 2-tert-butylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl methacrylate, dimethylaminopropylmethacrylamide, diethylaminopropylmethacrylamide, N-3-dimethylaminopropylacrylamide, 2-methacryloyloxyethyltrimethylammonium methosulfate, 2-diethyl-aminoethyl methacrylate, 2-methacryloyloxyethyltrimethylammonium chloride, 3-methacryloylaminopropyltrimethylammonium methosulfate, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

7. The wallcovering according to claim 1, wherein said antimicrobial polymer comprises a copolymer with at least one aliphatically unsaturated monomer selected from the group consisting of acrylic acid, tert-butyl methacrylate, methyl methacrylate, ethyl methacrylate, butyl methacrylate, methyl acrylate, ethyl acrylate, butyl acrylate, tert-butyl acrylate, styrene or its derivatives, vinyl chloride, vinyl ethers, acrylamides, acrylonitriles, olefins, allyl compounds, vinyl ketones, vinylacetic acid, vinyl acetate, and vinyl esters.

8. A wallcovering comprising a paper backing with a coating which comprises at least one antimicrobial polymer.

9. The wallcovering according to claim 8, wherein said at least one antimicrobial polymer is present at 0.01 to 70% by weight.

10. The wallcovering according to claim 8, wherein said coating further comprises a non-biocidal polymer.

11. The wallcovering according to claim 10, wherein said non-biocidal polymer is selected from the group consisting of PVC, polyurethane, polystyrene, polymethyl methacrylate, polyethylene, polypropylene, and polyacrylates, and mixtures thereof.

12. The wallcovering according to claim 8, further comprising paper fibers, pulp, wood particles, woodchips, cellulose, polymer fibers, textile fibers, cotton fibers, jute fibers, silk fibers, linen fibers, viscose fibers, or velour fibers, or combinations thereof.

13. The wallcovering according to claim 8, wherein said antimicrobial polymer comprises nitrogen-functionalized monomers, phosphorous-functionalized monomers, or combinations thereof.

14. The wallcovering according to claim 8, wherein said antimicrobial polymer comprises at least one monomer selected from the group consisting of 2-tert-butylaminoethyl methacrylate, 2-diethylaminoethyl methacrylate, 2-diethylaminomethyl methacrylate, 2-tertbutylaminoethyl acrylate, 3-dimethylaminopropyl acrylate, 2-diethylaminoethyl acrylate, 2-dimethylaminoethyl methacrylate, dimethylaminopropylmethacrylamide, diethylaminopropylmethacrylamide, N-3-dimethylaminopropylacrylamide, 2-methacryloyloxyethyltrimethylammonium methosulfate, 2-diethyl-aminoethyl methacrylate, 2-methacryloyloxyethyltrimethylammonium chloride, 3-methacryloylaminopropyltrimethylammonium methosulfate, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

15. The wallcovering according to claim 12, wherein said antimicrobial polymer comprises a copolymer with at least one aliphatically unsaturated monomer selected from the group consisting of acrylic acid, tert-butyl methacrylate, methyl methacrylate, ethyl methacrylate, butyl methacrylate, methyl acrylate, ethyl acrylate, butyl acrylate, tert-butyl acrylate, styrene or its derivatives, vinyl chloride, vinyl ethers, acrylamides, acrylonitriles, olefins, allyl compounds, vinyl ketones, vinylacetic acid, vinyl acetate, and vinyl esters.

16. A process for producing antimicrobial wallcoverings, comprising providing a paper backing with a coating comprising at least one antimicrobial polymer.

17. The process according to claim 16, wherein said coating further comprises a nonbiocidal polymer.

18. The process according to claim 16, wherein said coating is produced by thermal gelling of a plastisol comprising antimicrobial polymers.

19. A process for producing antimicrobial wallcoverings, comprising securing polymer fibers, textile fibers, cotton fibers, jute fibers, silk fibers, linen fibers, viscose fibers, or velour fibers, or combinations thereof, which comprises at least one antimicrobial polymer to a paper backing.

20. The process according to claim 19, wherein said securing further comprises a non-biocidal polymer.

21. A process for producing antimicrobial wallcoverings, comprising securing polymer fibers, textile fibers, cotton fibers, jute fibers, silk fibers, linen fibers, viscose fibers, or velour fibers, or combinations thereof, to a paper backing which comprises at least one antimicrobial polymer.

22. The process according to claim 21, wherein said paper backing further comprises a non-biocidal polymer.

23. A process for producing antimicrobial wallcoverings, comprising adding at least one antimicrobial polymer to a mixture made from at least one of paper fibers, pulp, wood particles, woodchips, cellulose, polymer fibers, textile fibers, cotton fibers, jute fibers, silk fibers, linen fibers, viscose fibers, or velour fibers, or combinations thereof, and processing the mixture to generate a paper backing.

24. The process according to claim 23, wherein said mixture further comprises a nonbiocidal polymer.
